(19) United States
(12) Patent Application Publication
(10) Pub. No.: US 2026/0111168 A1
(43) Pub. Date: Apr. 23, 2026

(54) ELECTRONIC DEVICE, METHOD, PROGRAM AND STORAGE MEDIUM FOR ADJUSTING VOLUME ADAPTIVELY TO NOISE

(71) Applicant: SAMSUNG ELECTRONICS CO., LTD., Suwon-si (KR)

(72) Inventors: Jungyeol AN, Suwon-si (KR); Gangyoul KIM, Suwon-si (KR); Jaehyun KIM, Suwon-si (KR); Vadim KUDRYAVTSEV, Suwon-si (KR); Jihoon SONG, Suwon-si (KR)

(21) Appl. No.: 19/411,168

(22) Filed: Dec. 5, 2025

Related U.S. Application Data
(63) Continuation of application No. PCT/KR2025/016519, filed on Oct. 17, 2025.

(30) Foreign Application Priority Data
Oct. 20, 2024 (KR) 10-2024-0143522
Nov. 26, 2024 (KR) 10-2024-0170505

(51) Int. Cl. G06F 3/16

(52) U.S. Cl. CPC G06F 3/165

(57) ABSTRACT

An electronic device includes a microphone, memory storing instructions, and one or more processors. The instructions, when executed, cause the electronic device to perform operations that include obtaining a volume adjusting model representing a target signal level relative to a noise level and obtaining a first audio signal through the microphone. The operations further include obtaining, based on media being played by the electronic device or a paired electronic device at a playback volume, a second audio signal of the media. The operations additionally include adjusting the playback volume, based on the volume adjusting model, a first intensity of the first audio signal corresponding to the noise level, and a second intensity of the second audio signal corresponding to the target signal level. The operations also include updating the volume adjusting model, based on the playback volume being maintained for a period of time exceeding a first threshold time.

### CROSS-REFERENCE TO RELATED APPLICATIONS

This application is a continuation application under, 35 U.S.C. § 111 (a), of International Patent Application No. PCT/KR2025/016519, filed on Oct. 17, 2025, which claims priority to Korean Patent Application No. 10-2024-0143522, filed on Oct. 20, 2024, and Korean Patent Application No. 10-2024-0170505, filed on Nov. 26, 2024, the content of which in their entirety is herein incorporated by reference.

### BACKGROUND

### 1. Field

The disclosure relates to a method and electronic device for adaptively adjusting volume in response to noise.

### 2. Description of Related Art

With the increasing use of portable electronic devices such as smartphones, tablet Personal Computers (PCs), and laptops, the use of wearable electronic devices, which can be worn on a user's body, is also increasing.

For example, as the wearable electronic device, the user may use earphones or headphones to be coupled to the electronic devices such as the smartphones, the tablet PCs, or the laptops. The earphones and the headphones provide various functions, such as voice calls, music playback, and voice command recognition. In particular, wireless earphones and wireless headphones allow the user to move freely, enabling the user to conveniently use them even during daily activities.

The earphones and the headphones offer the advantage of allowing the user to conveniently listen to music or make phone calls. However, when such convenience leads to longer usage time, it may have a negative impact on the user's hearing. For example, when the user wears the earphones or the headphones for an extended period of time, ear fatigue may be accumulated, and continuous exposure to sound may adversely affect the user's hearing. Furthermore, continuous exposure to high-volume sounds may put the user at risk of hearing loss, and the high-volume sounds may cause permanent damage to auditory cells and thus lead to noise-induced hearing loss. In particular, users who use the earphones or the headphones in noisy environments may raise volume to cover surrounding noise, thereby further increasing the risk of hearing loss.

Therefore, for hearing protection, it is important to maintain appropriate volume when using the earphones or the headphones, and for the users to take breaks at regular time intervals. In addition, the users may prevent hearing loss by using earphones or headphones equipped with a noise cancelling function.

### SUMMARY

According to an embodiment, a method including one or more operations is provided. The method includes obtaining a volume adjusting model representing a target signal level relative to a noise level. The method also includes obtaining a first audio signal through a microphone of an electronic device. The method further includes obtaining, based on media being played by the electronic device or a paired electronic device at a playback volume, a second audio signal of the media. The method additionally includes adjusting the playback volume, based on the volume adjusting model, a first intensity of the first audio signal corresponding to the noise level, and a second intensity of the second audio signal corresponding to the target signal level. The method also includes updating the volume adjusting model, based on the playback volume being maintained for a period of time exceeding a first threshold time.

According to an embodiment, an electronic device including a microphone, a memory storing instructions, and one or more processors is provided. The instructions, when individually or collectively executed by the one or more processors, cause the electronic device to perform one or more operations. The one or more operations include obtaining a volume adjusting model representing a target signal level relative to a noise level. The one or more operations also include obtaining a first audio signal through the microphone of the electronic device. The one or more operations further include obtaining, based on media being played by the electronic device or a paired electronic device at a playback volume, a second audio signal of the media. The one or more operations additionally include adjusting the playback volume, based on the volume adjusting model, a first intensity of the first audio signal corresponding to the noise level, and a second intensity of the second audio signal corresponding to the target signal level. The one or more operations also include updating the volume adjusting model, based on the playback volume being maintained for a period of time exceeding a first threshold time.

A computer-readable non-transitory recording medium according to an embodiment of the disclosure stores one or more commands and/or instructions, when executed, cause an electronic device to perform the aforementioned method and operations of the electronic device.

### BRIEF DESCRIPTION OF DRAWINGS

In the description of the drawings, the same or similar reference numerals may be used to indicate the same or similar elements.

FIG. 1 is a flowchart of a method of adaptively adjusting volume in response to noise according to an embodiment;

FIG. 2 is a graph for describing a volume adjusting model according to an embodiment;

FIG. 3 is a flowchart of a method of updating a volume adjusting model according to an embodiment;

FIG. 4 is a flowchart of a method of calibrating a volume adjusting model by estimating a sound dose of a user according to an embodiment;

FIG. 5 is a table for describing a method of calculating a cumulative playback time per noise level range to estimate a sound dose of a user according to an embodiment;

FIG. 6 is a graph for describing a method of calculating a cumulative playback time per noise level range to estimate a sound dose of a user according to an embodiment;

FIG. 7 is a table for describing an allowable sound dose according to an embodiment;

FIG. 8 is a graph for describing a calibrated volume adjusting model according to an embodiment;

FIG. 9 is a block diagram of a wearable electronic device according to an embodiment;

FIG. 10 is a block diagram of an electronic device according to an embodiment; and

FIG. 11 is a block diagram of an audio module according to an embodiment.

### DETAILED DESCRIPTION

Hereinafter, embodiments of the disclosure will be described in detail with reference to the accompanying drawings so that those skilled in the art can easily implement the disclosure. However, the disclosure may be realized in various different forms and is not limited to the embodiments described herein. In addition, in order to clearly describe the disclosure, parts not related to the description are omitted in the drawings, and similar reference numerals are given to similar parts throughout the specification.

Terms used in the disclosure are described as general terms currently in use in consideration of functions mentioned in the disclosure, but may mean various other terms depending on the intention of a technician engaged in the relevant field, precedents, emergence of new technologies, or the like. Therefore, the terms used in the disclosure shall not be interpreted only based on the name of the term, but shall be interpreted based on the meaning of the term and the overall content of the disclosure.

In addition, the terms ‘1st’, ‘2nd’, ‘3rd’, . . . , ‘Nth’ may be used to describe various components, but the components shall not be limited by these terms. The terms are used to distinguish one component from another.

Throughout the specification, when a part is mentioned to be “connected” to another part, this includes not only a case where it is “directly connected” but also a case where it is “electrically connected” thereto with other elements interposed therebetween. Also, when a part is mentioned to “include” a component, this does not mean that it excludes other components, but rather that it may further include other components, unless otherwise specified.

Phrases such as “according to an embodiment” mentioned in various sections of this disclosure do not necessarily all refer to the same embodiment.

An embodiment of the disclosure may be represented by functional block configurations and various processing steps. Some or all of these functional blocks may be implemented as a variety of hardware and/or software components which perform specific functions. For example, the functional blocks of the disclosure may be implemented by one or more microprocessors, or may be implemented by circuit configurations designed for specific functions. Further, for example, the functional blocks of the disclosure may be implemented as various programming or scripting languages. The functional blocks may also be implemented as algorithms executed on one or more processors. Furthermore, the disclosure may employ the prior art for electronic environment configurations, signal processing, and/or data processing. Terms such as “mechanism,” “element,” “means,” and “configuration” are used broadly herein, and are not limited to mechanical or physical configurations.

In addition, connecting lines or connecting members between components shown in the drawings are provided merely as examples of functional connections and/or physical or circuit connections. In actual devices, the connections between the components may be implemented by various alternative or additional functional, physical, or circuit connections.

Hereinafter, the disclosure will be described in detail with reference to the accompanying drawings.

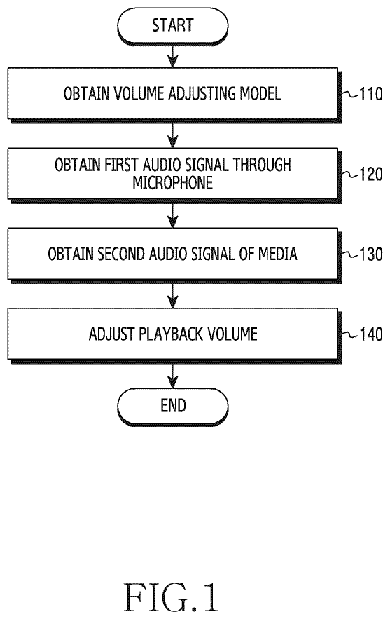

FIG. 1 is a flowchart of a method of adaptively adjusting volume in response to noise according to an embodiment.

In the following embodiment, each of the operations may be performed sequentially, but may not be necessarily performed sequentially. For example, the order of the operations may be changed, and at least two operations may be performed in parallel.

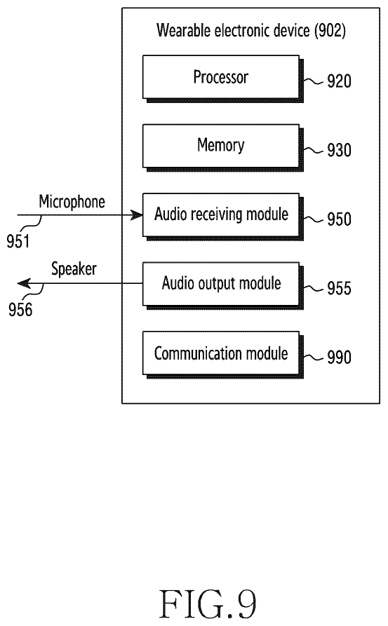

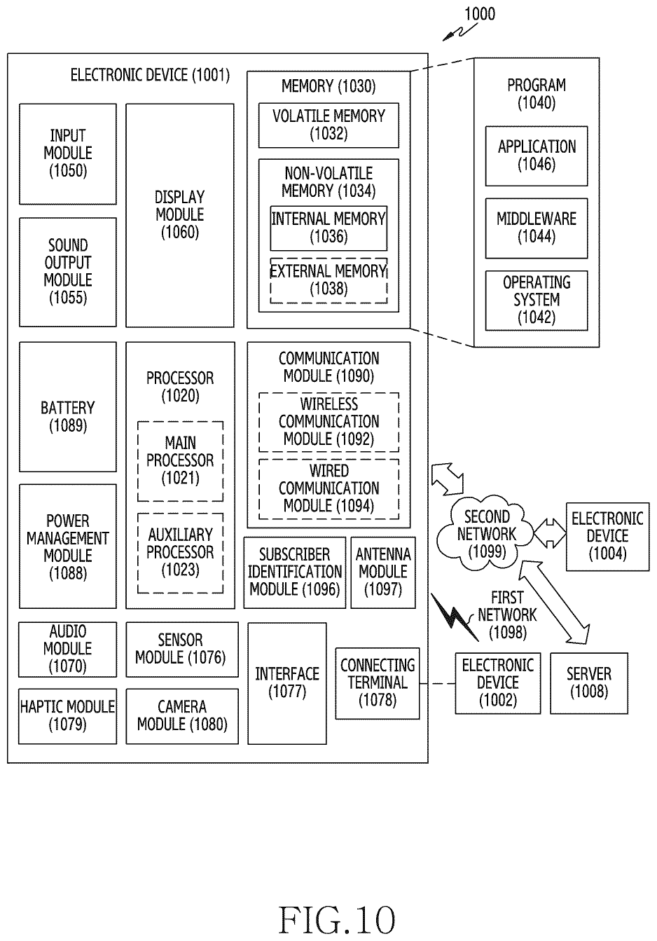

According to an embodiment, in operation 110, a wearable electronic device (e.g., a wearable electronic device 902 of FIG. 9 or an electronic device 1001 of FIG. 10) may obtain a volume adjusting model. The volume adjusting model may represent a target signal level relative to a noise level.

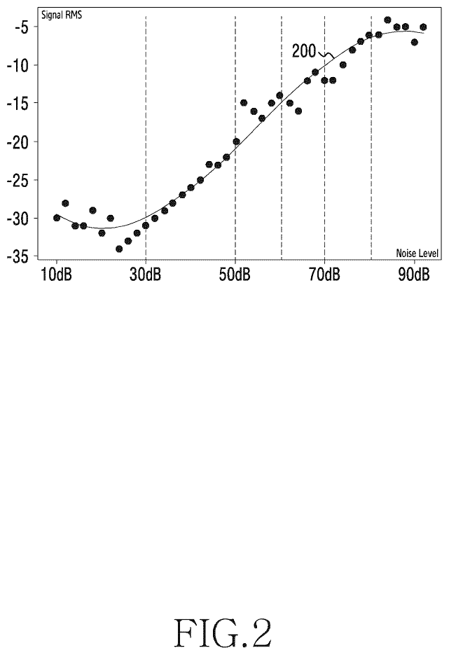

The volume adjusting model will be described with reference to FIG. 2.

FIG. 2 is a graph for describing a volume adjusting model according to an embodiment.

The graph of FIG. 2 visualizes a volume adjusting model 200 as a curve, with noise levels arranged on a horizontal axis and target signal levels represented on a vertical axis. The noise level may correspond to a noise intensity level in an environment surrounding an electronic device, and the target signal level may correspond to an intensity level of an audio signal output from the electronic device.

Referring to FIG. 2, the target signal level may be represented as a level subtracted from 0 dB, which is a maximum volume of a digital audio signal. For example, referring to FIG. 2, for a noise level in the range of 10 dB to 30 dB, the target signal level may be in the range of −35 dB to −30 dB. For a noise level in the range of 30 dB to 50 dB, the target signal level may be in the range of −30 dB to −20 dB. For a noise level in the range of 50 dB to 60 dB, the target signal level may be in the range of −20 dB to −15 dB. For a noise level in the range of 60 dB to 70 dB, the target signal level may be subtracted by a level in the range of −15 dB to −10 dB. For a noise level in the range of 70 dB to 80 dB, the target signal level may be in the range of −10 dB to −8 dB. As the noise level decreases, the target signal level also decreases, resulting in media being played back at a lower playback volume. This prevents a user from being exposed to sound at an unnecessarily high playback volume, thereby helping to prevent hearing damage or loss. As the noise level increases, the target signal level also increases, resulting in media being played back at a higher playback volume. This prevents the sound of the media from being masked by surrounding noise.

According to an embodiment, the noise level and the target signal level may be represented based on Root-Mean-Square (RMS), but are not limited thereto.

According to an embodiment, the volume adjusting model may be created by calculating the target signal level relative to the noise level, based on big data, such as data from large data sets collected from one or more data sources associated with audio data in various environments. The wearable electronic device may have the created volume adjusting model pre-installed or may receive the volume adjusting model from an electronic device (e.g., an electronic device 1002 or 1004 of FIG. 10) paired with the wearable electronic device. According to an embodiment, the wearable electronic device may receive the volume adjusting model distributed by a server (e.g., a server 1008 of FIG. 10) via the electronic device.

According to an embodiment, in operation 120, the wearable electronic device may obtain a first audio signal through a microphone (e.g., an input module 1050 of FIG. 10). The first audio signal may represent external noise of the wearable electronic device, which is obtained through the microphone. The first audio signal may be continuously obtained on a real-time basis by the wearable electronic device, and the first audio signal is variable over time. The first audio signal has a first intensity, and the first intensity is variable over time.

According to an embodiment, in operation 130, the wearable electronic device may obtain a second audio signal of media. The second audio signal may represent an audio signal to be output through a speaker (e.g., an audio output module 1055 of FIG. 10) of the wearable electronic device. The second audio signal may be continuously obtained on a real-time basis by the wearable electronic device, and the second audio signal is variable over time.

According to an embodiment, the wearable electronic device may obtain the second audio signal of the media, based on the media being played at a playback volume by an electronic device paired with the wearable electronic device. The wearable electronic device may obtain the second audio signal from the electronic device. For example, the wearable electronic device may obtain the second audio signal from the electronic device through a Bluetooth network. However, the disclosure is not limited thereto, and the second audio signal may be obtained through a wired connection, or the second audio signal may be obtained from the electronic device through another wireless communication network.

According to an embodiment, the second audio signal may be a digital audio signal prior to being converted to analog and output by the wearable electronic device. A second intensity of the second audio signal is a signal intensity of the digital audio signal, and may be represented by being subtracted from 0 dB, which is a maximum volume of the digital audio signal.

According to an embodiment, in operation 140, the wearable electronic device may adjust the playback volume. For example, the wearable electronic device may adjust the playback volume, based on the volume adjusting model obtained in the operation 110, the first intensity of the first audio signal obtained in the operation 120, and the second intensity of the second audio signal obtained in the operation 130.

The first audio signal obtained in the operation 120 is variable, and the first intensity of the first audio signal is also variable over time. Therefore, the first intensity, which is referenced to adjust the playback volume, may be a value calculated as a weighted average of the first intensities per unit time of the first audio signal.

According to an embodiment, the unit time may be 10 seconds, 5 seconds, 1 second, 0.1 second, 0.01 second, or 0.001 second, but is not limited thereto. As the unit time decreases, data resolution improves, resulting in a greater processing burden on the wearable electronic device. Therefore, an appropriate unit time may be selected according to the wearable electronic device or user's preferences or tendencies.

According to an embodiment, a highest weight may be applied to an intensity of a signal obtained most recently among the first audio signals continuously obtained on a real-time basis.

The second audio signal obtained in the operation 130 is variable, and the second intensity of the second audio signal is also variable over time. Therefore, the second intensity, which is referenced to adjust the playback volume, may be a value calculated as a weighted average of the second intensities per unit time of the second audio signal.

According to an embodiment, the unit time may be 10 seconds, 5 seconds, 1 second, 0.1 second, 0.01 second, or 0.001 second, but is not limited thereto. As the unit time decreases, data resolution improves, resulting in a greater processing burden on the wearable electronic device. Therefore, an appropriate unit time may be selected according to the wearable electronic device. According to an embodiment, a highest weight may be applied to an intensity of a signal obtained most recently among the second audio signals continuously obtained on a real-time basis.

According to an embodiment, the wearable electronic device may adjust the playback volume, based on the second intensity of the second audio signal deviating from a threshold range (e.g., ±5 dB) of a target signal level relative to a noise level corresponding to the first intensity in the volume adjusting model, for a period of time exceeding a threshold time (e.g., 10 seconds).

For example, when a user wearing the wearable electronic device is watching a movie in a quiet library, and the first intensity of the first audio signal obtained in an environment of the quiet library may be 30 dB, and the volume adjusting model of FIG. 2 can indicate a target signal level of −30 dB. When the intensity of the audio signal of the movie being played back by the wearable electronic device remains within the range of −25 dB to −35 dB, that is, the threshold range of −30 dB, the wearable electronic device may continue to maintain the playback volume. When the intensity of the audio signal of the movie being played back by the wearable electronic device deviates from the range of −35 dB to −25 dB, that is, the threshold range of −30 dB, and a period of the deviation from the threshold range exceeds a threshold time (e.g., 10 seconds), the wearable electronic device may adjust the playback volume. For example, when a weighted average value of the intensities of the audio signal is −20 dB which is greater than −25 dB, and remains at a value (e.g., −20 dB) greater than −25 dB for a period of time exceeding 10 seconds, the wearable electronic device may decrease the playback volume of the movie. According to an embodiment, an adjustment amount of the playback volume may be proportional to a degree to which the second intensity deviates from the threshold range, but is not limited thereto. The playback volume may be adjusted in minimal adjustment units permitted by the wearable electronic device, which facilitates the prevention of hearing damage or loss without interfering with the user's listening experience.

For example, when the weighted average value of the intensities of the audio signal is −40 dB which is less than −35 dB, and remains at a value (e.g., −40 dB) smaller than −35 dB for a period of time exceeding 10 seconds, the wearable electronic device may increase the playback volume. According to an embodiment, an adjustment amount of the playback volume may be proportional to a degree to which the second intensity deviates from the threshold range, but is not limited thereto. For example, the playback volume may be adjusted in minimal adjustment units permitted by the wearable electronic device, which facilitates the prevention of a sound of a movie from being masked by surrounding noise without interfering with the user's listening experience.

According to an embodiment, even if an original signal has a different intensity depending on content, the playback volume can be adjusted based on the intensity of the digital audio signal prior to being converted to analog and output by the wearable electronic device. Therefore, the content may be played back at an appropriate playback volume regardless of the content.

According to an embodiment, the wearable electronic device can adjust the playback volume when the second intensity of the second audio signal deviates from a threshold range for a period of time exceeding a threshold time, thereby preventing sudden adjustment of the playback volume, which may startle the user or cause hearing damage or loss.

According to an embodiment, the operations 110, 120, 130, and 140 may be understood as being performed by a processor (e.g., a processor 920 of FIG. 9 or a processor 1020 of FIG. 10) of an electronic device (e.g., the wearable electronic device 902 of FIG. 9 or the electronic device 1001 of FIG. 10).

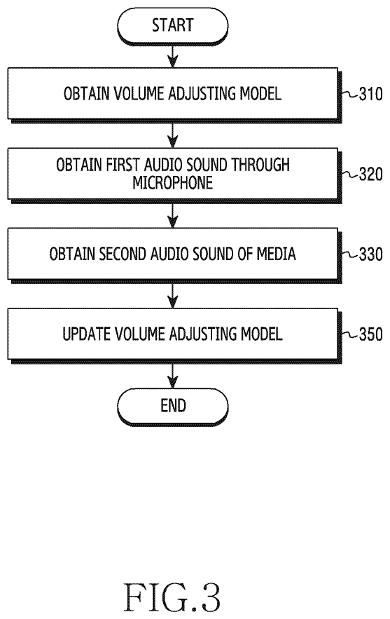

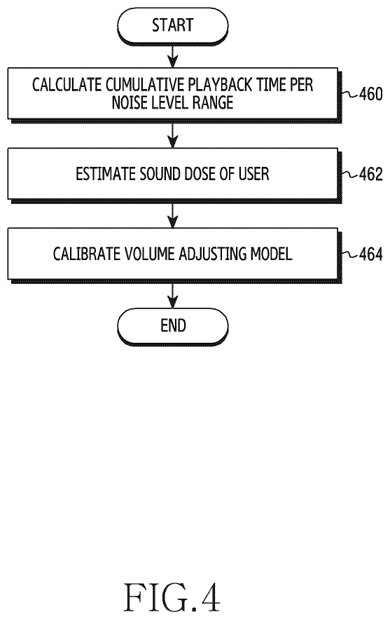

According to an embodiment, the volume adjusting model may be updated or calibrated, and the wearable electronic device may adjust the playback volume, based on the updated or calibrated volume adjusting model. A method of updating the volume adjusting model will be described with reference to FIG. 3. A method of calibrating the volume adjusting model will be further described with reference to FIG. 4 to FIG. 8.

FIG. 3 is a flowchart of a method of updating a volume adjusting model according to an embodiment.

In the following embodiment, each of the operations may be performed sequentially, but may not be necessarily performed sequentially. For example, the order of the operations may be changed, and at least two operations may be performed in parallel.

Operations 310, 320, and 330 of FIG. 3 correspond, respectively, to the operations 110, 120, and 130 of FIG. 1, and thus redundant descriptions will be omitted.

According to an embodiment, in operation 350, the wearable electronic device may update the volume adjusting model. For example, the wearable electronic device may update the volume adjusting model, based on a media playback volume being maintained for a period of time exceeding a threshold time (e.g., 10 minutes). The fact that a user has not changed the playback volume for the period of time exceeding the threshold time may be regarded as indicating that the user is satisfied with an intensity of an audio signal of media being played back at a current noise level. Therefore, in order to incorporate such user preferences in the volume adjusting model, when the user has not changed the playback volume for a period of time exceeding 10 minutes, the wearable electronic device may add a noise level and an intensity level of the audio signal of the media during the period to the volume adjusting model. Data to be added as described above may be represented as individual points in the graph of FIG. 2, and the volume adjusting model, which is represented as a curve, may be updated according to the added points. For example, when the user continuously enjoys the media while maintaining a high playback volume in an environment with a noise level of 50 dB, and the intensity of the audio signal of the media is −15 dB, the curve of FIG. 2, which indicates a target signal intensity of −20 dB at a noise level of 50 dB, may be updated to indicate a target signal level of −15 dB at the noise level of 50 dB.

According to an embodiment, new data may be incorporated into the volume adjusting model, based on the maintained playback volume, thereby enabling a customized volume adjusting model to be provided to the user. If the volume adjusting model is updated based on the adjustment of the playback volume rather than the maintenance of the playback volume, the model may also be updated even when the playback volume is adjusted in unintended situations (e.g., when someone nearby speaks to the user, causing the user to reduce the playback volume), and the updated volume adjusting model may not match the user's intent. On the other hand, in an embodiment, since the volume adjusting model is updated based on the maintenance of the playback volume, new data is incorporated into the volume adjusting model while media is being played back with the maintained playback volume. Therefore, the volume adjusting model may be updated in a manner that matches the user's intent.

According to an embodiment, if the playback volume changes before a threshold time (e.g., 10 minutes) elapses while the media is being played back, data accumulated until a threshold time elapses can be discarded without being incorporated into the volume adjusting model, and a period in which a playback volume is maintained may be recounted to determine whether the period in which the playback volume is maintained exceeds the threshold time. Accordingly, data corresponding to the period, in which the playback volume is maintained, exceeding the threshold time may be incorporated into the volume adjusting model. As the threshold time decreases, the volume adjusting model is updated more frequently to be further customized for the user, data resolution improves, and it results in a greater processing burden on the wearable electronic device. Therefore, an appropriate threshold time may be selected according to the wearable electronic device or user's preferences or tendencies.

According to an embodiment, in operation 350, the wearable electronic device may adjust the playback volume, based on the updated volume adjusting model.

According to an embodiment, the volume adjusting model obtained in the operation 110 of FIG. 1 may be updated or calibrated, and the wearable electronic device may adjust the playback volume, based on the updated volume adjusting model or the calibrated volume adjusting model. According to an embodiment, the volume adjusting model updated in the operation 350 of FIG. 3 may be further updated, or the volume adjusting model calibrated in the operation 464 of FIG. 4 may be further updated.

According to an embodiment, the operations 310, 320, 330, and 350 may be understood as being performed by a processor (e.g., a processor 920 of FIG. 9 or the processor 1020 of FIG. 10) of an electronic device (e.g., the wearable electronic device 902 of FIG. 9 or the electronic device 1001 of FIG. 10).

According to an embodiment, the volume adjusting model may be calibrated, and the wearable electronic device may adjust the playback volume, based on the calibrated volume adjusting model. A method of calibrating the volume adjusting model will be described with reference to FIG. 4 to FIG. 8.

FIG. 4 is a flowchart of a method of calibrating a volume adjusting model by estimating a sound dose of a user according to an embodiment.

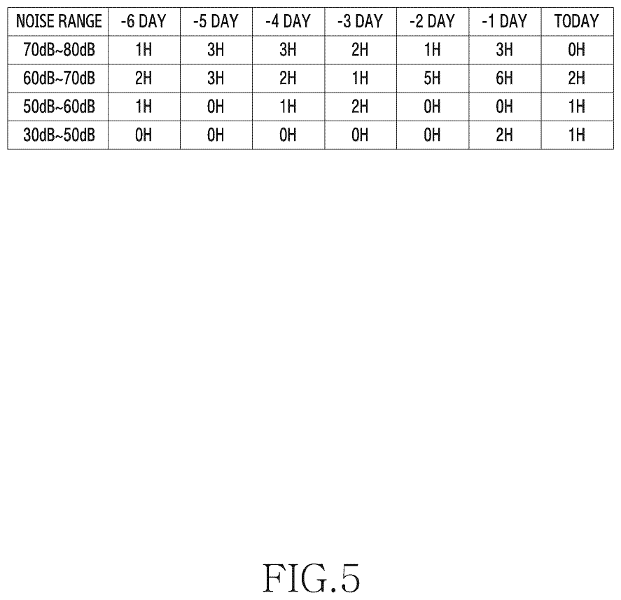

FIG. 5 is a table for describing a method of calculating a cumulative playback time per noise level range to estimate a sound dose of a user according to an embodiment.

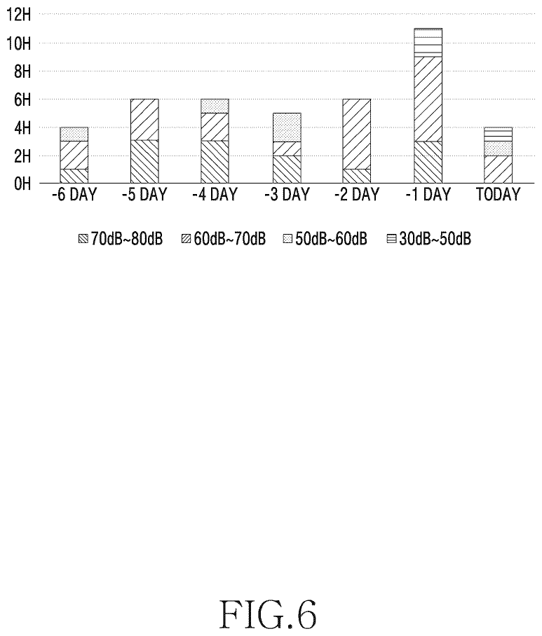

FIG. 6 is a graph for describing a method of calculating a cumulative playback time per noise level range to estimate a sound dose of a user according to an embodiment.

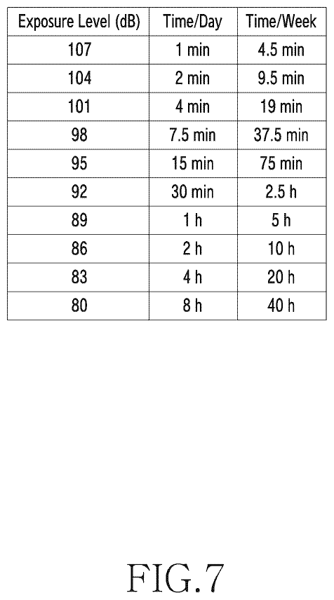

FIG. 7 is a table for describing an allowable sound dose according to an embodiment.

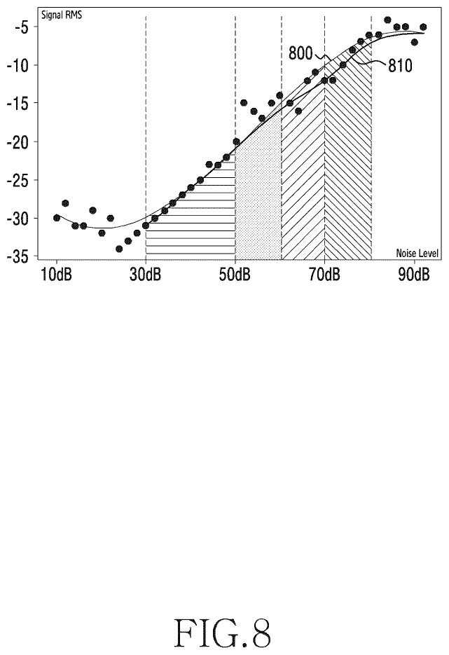

FIG. 8 is a graph for describing a calibrated volume adjusting model according to an embodiment.

In the following embodiment, each of the operations may be performed sequentially, but may not be necessarily performed sequentially. For example, the order of the operations may be changed, and at least two operations may be performed in parallel.

According to an embodiment, in operation 460, the wearable electronic device may calculate the cumulative playback time per noise level range. The cumulative playback time may refer to a total playback time accumulated over a predetermined period (e.g., 7 days).

Referring to FIG. 5, the wearable electronic device indicates that, within a noise level range of 70 dB to 80 dB, playback times for today, one day ago, two days ago, three days ago, four days ago, five days ago, and six days ago are 0 hours, 3 hours, 1 hour, 2 hours, 3 hours, 3 hours, and 1 hour, respectively. Accordingly, a cumulative playback time corresponding to a noise level range of 70 dB to 80 dB can be calculated to be 13 hours. Further, a cumulative playback time corresponding a noise level range of 60 dB to 70 dB can be calculated to be 21 hours. A cumulative playback time corresponding to a noise level range of 50 dB to 60 dB can be calculated to be 5 hours. A cumulative playback time corresponding to a noise level range of 30 dB to 50 dB can be calculated to be 3 hours. Furthermore, referring to FIG. 6, total playback times of the wearable electronic device for today, one day ago, two days ago, three days ago, four days ago, five days ago, and six days ago can be 4 hours, 11 hours, 6 hours, 5 hours, 6 hours, 6 hours, and 4 hours, respectively.

According to an embodiment, a highest weight may be applied to a playback time of a most recent date, and a lowest weight may be applied to a playback time of an oldest date, for example, six days ago.

According to an embodiment, in operation 462, the wearable electronic device may estimate a sound dose of a user. The wearable electronic device may estimate the user's sound dose for a predetermined period, based on the volume adjusting model and the cumulative playback time calculated in the operation 460.

According to an embodiment, the user's sound dose or an exposure level may correspond to the noise level range. For example, when the user has played back media for a total of 13 hours in a noise level range of 70 dB to 80 dB, the user's sound dose may be calculated as being exposed to noise in the range of 70 dB to 80 dB for 13 hours, but is not limited thereto. For example, the user's sound dose may be calculated as being exposed to noise of 75 dB for 13 hours. Since actual user's experience partial blocking of ambient noise by wearing the wearable electronic device, the volume adjusting model may be referenced to take this into account. According to the volume adjusting model, a target signal intensity corresponding to a noise level range of 70 dB to 80 dB can be −10 dB. A target signal intensity corresponding to a noise level range of 60 dB to 70 dB can be −12 dB. A target signal intensity corresponding to a noise level range of 50 dB to 60 dB can be −17 dB. A target signal intensity corresponding to a noise level range of 30 dB to 50 dB can be −25 dB. Therefore, a user's sound dose corresponding to an average noise level of 75 dB within a noise level range of 70 dB to 80 dB may be calculated by subtracting 10 dB, i.e., 65 dB over 13 hours. A user's sound dose corresponding to an average noise level of 65 dB within a noise level range of 60 dB to 70 dB may be calculated by subtracting 12 dB, i.e., 53 dB over 21 hours. A user's sound dose corresponding to an average noise level of 55 dB within a noise level range of 50 dB to 60 dB may be calculated by subjecting 17 dB, i.e., as 38 dB over 5 hours. A user's sound dose corresponding to an average noise level of 40 dB within a noise level range of 30 dB to 50 dB may be calculated by subtracting 25 dB, i.e., as 15 dB over 6 hours. However, the user's sound doses are not limited thereto.

According to an embodiment, the user's sound dose may be calculated according to Equation 1 below.

$$E = 1 / T * {\int }_{-} {0}^{∧} T P ( t ) \hat{} 2 dt \qquad [ Equation 1 ]$$

In Equation 1, T denotes a total playback time. P(t) denotes a weighted average sound pressure level over a time t.

According to an embodiment, in operation 464, the wearable electronic device may calibrate the volume adjusting model. According to an embodiment, the wearable electronic device may calibrate the volume adjusting model, so that the user's sound dose is below an allowable sound dose.

The allowable sound dose may be defined as a dose permitted over one day or one week according to each noise exposure level as shown in FIG. 7. The allowable sound dose may be specified in various manners.

According to an embodiment, when a ratio of the user's sound dose to the allowable sound dose exceeds 100%, the volume adjusting model may be calibrated. According to an embodiment, portions respectively corresponding to a plurality of noise level ranges in the volume adjusting model may be calibrated based on a ratio of a plurality of cumulative playback times corresponding to the plurality of noise level ranges.

For example, referring to FIG. 5 and FIG. 6, percentages (e.g., 32%, 51%, 12%, 5%) occupied by a plurality of cumulative playback times (e.g., 13 hours, 21 hours, 5 hours, 3 hours) respectively corresponding to a plurality of noise level ranges (e.g., 70 dB to 80 dB, 60 dB to 70 dB, 50 dB to 60 dB, 30 dB to 50 dB) may be calculated, and a calibration value for a corresponding target signal level may be determined in proportion to the calculated percentage. That is, a target signal level corresponding to a noise level range of 60 dB to 70 dB, which has a largest calculated percentage, may be calibrated most significantly, and a target signal level corresponding to a noise level range of 70 dB to 80 dB, which has a second largest calculated percentage, may be calibrated next most significantly. For example, a bold line 810 in FIG. 8 indicates a calibrated volume adjusting model 810. Referring to the calibrated adjusting model 810, a target signal level corresponding to a noise level of 60 dB to 70 dB and a target signal level corresponding to a noise level range of 70 dB to 80 dB may be calibrated to have lower values compared to those of a pre-calibration volume adjusting model 800 which is indicated by a thin (e.g., non-bold) line 800. On the other hand, target signal magnitudes corresponding to noise level ranges (30 dB to 60 dB) with relatively low calculated percentages may be less affected by the calibration.

According to an embodiment, the wearable electronic device may adjust the playback volume, based on the volume adjusting model calibrated in the operation 464. According to an embodiment, the volume adjusting model is proactively calibrated by estimating the user's sound dose, thereby preventing user's hearing damage or loss.

According to an embodiment, the volume adjusting model obtained in the operation 110 of FIG. 1 may be updated or calibrated, and the wearable electronic device may adjust the playback volume, based on the updated volume adjusting model or the calibrated volume adjusting model. According to an embodiment, the volume adjusting model updated in the operation 350 of FIG. 3 may be calibrated, or the volume adjusting model calibrated in the operation 464 of FIG. 4 may be further calibrated.

The expression “calibrating or updating the volume adjusting model” may be understood as modifying the volume adjusting model by incorporating new data.

According to an embodiment, the wearable electronic device may include a plurality of volume adjusting models. The plurality of volume adjusting models may be expressed by different corves. The plurality of volume adjusting models may include a volume adjusting model corresponding to a noise control mode of the wearable electronic device. For example, the plurality of volume adjusting models may include a first volume adjusting model corresponding to a noise cancelling mode, a second volume adjusting model corresponding to an ambient sound listening mode, and a third volume adjusting model corresponding to a state in which the noise cancelling mode is deactivated. Since ambient noise is eliminated when the noise cancelling mode is activated, the first volume adjusting model corresponding to this mode may indicate overall lower target signal levels compared to other volume adjusting models affected by the ambient noise. A curve of the first volume adjusting model may exhibit a gentler slope than curves of the other volume adjusting models. On the other hand, since the second volume adjusting model corresponding to the ambient sound listening mode are most significantly affected by ambient noise, it may indicate overall higher target signal levels compared to the other volume adjusting models. A curve of the second volume adjusting model may exhibit a steeper slope than the other volume adjusting models.

According to an embodiment, the wearable electronic device may include a plurality of volume adjusting models. The plurality of volume adjusting models may be expressed by different curves. The plurality of volume adjusting models may include a volume adjusting model corresponding to a type of media being played back in the wearable electronic device. For example, the plurality of volume adjusting model may include a first volume adjusting model corresponding to news-type media, a second volume adjusting model corresponding to movie-type media, and a third volume adjusting model corresponding to music-type media. The news-type media may indicate overall higher target signal levels compared to the other volume adjusting models since clarity of message delivery is critical for the news-type media compared to the other media types. A curve of the first volume adjusting model may exhibit a steeper slope compared to curves of the other volume adjusting models. Media types can be further decomposed into various subtypes, such as sports content, action content, horror content, classical music, pop-rock music, country music, heavy metal music, rap performances, and so forth, where each subtype can have a customized volume adjusting model.

According to an embodiment, the operations 460, 462, and 464 may be understood as being performed by a processor (e.g., the processor 920 of FIG. 9 or the processor 1020 of FIG. 10) of an electronic device (e.g., the wearable electronic device 902 of FIG. 9 or the electronic device 1001 of FIG. 10).

According to an embodiment, a method including one or more operations may be provided. The method may include the operation 110 of obtaining a volume adjusting model representing a target signal level relative to a noise level. The method may include the operation 120 of obtaining a first audio signal through a microphone of an electronic device. The method may include the operation 130 of obtaining, based on media being played by the electronic device or a paired electronic device at a playback volume, a second audio signal of the media. The method may include the operation 140 of adjusting the playback volume, based on the volume adjusting model, a first intensity of the first audio signal corresponding to the noise level, and a second intensity of the second audio signal corresponding to the target signal level. The method may include the operation 350 of updating the volume adjusting model, based on the playback volume being maintained for a period of time exceeding a first threshold time.

According to an embodiment, the second intensity of the second audio signal may vary while the media is played at the playback volume.

According to an embodiment, the first intensity may be calculated as a weighted average of first intensities per unit time of the first audio signal. The second intensity may be calculated as a weighted average of second intensities per unit time of the second audio signal. The calculations can be performed by one or more processors of the electronic device or paired electronic device.

According to an embodiment, the adjusting of the playback volume may include adjusting the playback volume, based on the second intensity deviating from a threshold range of the target signal level relative to the noise level corresponding to the first intensity in the volume adjusting model, for a period of time exceeding a second threshold time.

According to an embodiment, the second threshold time may be shorter than the first threshold time.

According to an embodiment, the method may further include calculating a cumulative playback time per noise level range, based on the first intensity, and calibrating the volume adjusting model, based on the cumulative playback time. The calculating can be performed by one or more processors of the electronic device or paired electronic device.

According to an embodiment, the calibrating of the volume adjusting model may include estimating a sound dose of a user of the electronic device for a defined period, based on the cumulative playback time and the volume adjusting model, and calibrating the volume adjusting model such that the sound dose is below an allowable sound dose.

According to an embodiment, the calibrating of the volume adjusting model may include calibrating, based on a ratio of cumulative playback times corresponding to noise level ranges, portions respectively corresponding to the noise level ranges in the volume adjusting model.

According to an embodiment, the obtaining of the volume adjusting model may include identifying a noise control mode set in the electronic device, and obtaining, among a plurality of volume adjusting models, the volume adjusting model corresponding to the identified noise control mode.

According to an embodiment, the obtaining of the volume adjusting model may include identifying a type of the media, and obtaining, among a plurality of volume adjusting models, the volume adjusting model corresponding to the identified type of the media.

FIG. 9 is a block diagram of a wearable electronic device according to an embodiment.

Referring to FIG. 9, a wearable electronic device 902 may include a processor 920, a memory 930, an audio receiving module 950, an audio output module 955, and a communication module 990.

The wearable electronic device 902 may be an earphone or headphone to be coupled to an electronic device such as a smartphone, a tablet PC, or a laptop, but is not limited thereto.

The processor 920 may execute software to control at least one other component (e.g., a hardware or software component) of the wearable electronic device 902 coupled to the processor 920, and may perform various data processing or operations.

The processor 920 may execute instructions stored in the memory 930 to control operations of the wearable electronic device 902. For example, the processor 920 may correspond to a plurality of processors which collectively perform a plurality of operations by dividing the operations among the processors.

The processor 920 may be operatively coupled to the memory 930, the audio receiving module 950, the audio output module 955, and the communication module 990.

The memory 930 may store a variety of data used by at least one component (e.g., the processor 920, the audio receiving module 950, the audio output module 955, and the communication module 990) of the wearable electronic device 902.

The audio receiving module 950 may include a microphone 951 for obtaining an audio signal of an external environment of the wearable electronic device 902, but is not limited thereto.

The audio output module 955 may include a speaker 956 for outputting an audio signal of media in the wearable electronic device 902, but is not limited thereto.

The communication module 990 may include a Bluetooth module used by the wearable electronic device 902 to communicate with another electronic device (e.g., an electronic device 1001 of FIG. 10), but is not limited thereto.

FIG. 10 is a block diagram illustrating an electronic device 1001 in a network environment 1000 according to various embodiments.

Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

One or more processors 1020 may be provided. For example, the processor 1020 may have a multi-core structure, such as a dual core, quad core, or hexa core.

The processor 1020 may execute instructions stored in the memory 1030 to control operations of the electronic device 1001. For example, the processor 1020 may correspond to a plurality of processors which collectively perform a plurality of operations by dividing the operations among the processors.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mm Wave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device 1001 according to an embodiment may be the wearable electronic device 902 described with reference to FIG. 1 to FIG. 9, and the electronic device 1001 may perform the operations of the wearable electronic device 902 in FIG. 1 to FIG. 9. The electronic device 1001 according to an embodiment may communicate with the wearable electronic device 902 described with reference to FIG. 1 to FIG. 9, and the electronic device 1001 may allow the wearable electronic device 902 to perform the operations described with reference to FIG. 1 to FIG. 9. The electronic device 1001 can be paired with the wearable electronic device 902 to support communication, and either one of the electronic device 1001 or wearable electronic device 902 can be considered a paired electronic device relative to each other.

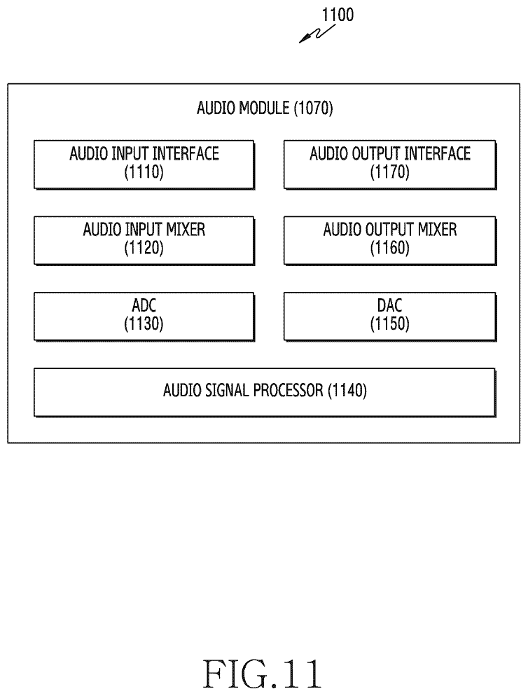

FIG. 11 is a block diagram 1100 illustrating the audio module 1070 according to various embodiments. Referring to FIG. 11, the audio module 1070 may include, for example, an audio input interface 1110, an audio input mixer 1120, an analog-to-digital converter (ADC) 1130, an audio signal processor 1140, a digital-to-analog converter (DAC) 1150, an audio output mixer 1160, or an audio output interface 1170.

The audio input interface 1110 may receive an audio signal corresponding to a sound obtained from the outside of the electronic device 1001 via a microphone (e.g., a dynamic microphone, a condenser microphone, or a piezo microphone) that is configured as part of the input module 1050 or separately from the electronic device 1001. For example, if an audio signal is obtained from the external electronic device 1002 (e.g., a headset or a microphone), the audio input interface 1110 may be connected with the external electronic device 1002 directly via the connecting terminal 1078, or wirelessly (e.g., Bluetooth™ communication) via the wireless communication module 1092 to receive the audio signal. According to an embodiment, the audio input interface 1110 may receive a control signal (e.g., a volume adjustment signal received via an input button) related to the audio signal obtained from the external electronic device 1002. The audio input interface 1110 may include a plurality of audio input channels and may receive a different audio signal via a corresponding one of the plurality of audio input channels, respectively. According to an embodiment, additionally or alternatively, the audio input interface 1110 may receive an audio signal from another component (e.g., the processor 1020 or the memory 1030) of the electronic device 1001.

The audio input mixer 1120 may synthesize a plurality of inputted audio signals into at least one audio signal. For example, according to an embodiment, the audio input mixer 1120 may synthesize a plurality of analog audio signals inputted via the audio input interface 1110 into at least one analog audio signal.

The ADC 1130 may convert an analog audio signal into a digital audio signal. For example, according to an embodiment, the ADC 1130 may convert an analog audio signal received via the audio input interface 1110 or, additionally or alternatively, an analog audio signal synthesized via the audio input mixer 1120 into a digital audio signal.

The audio signal processor 1140 may perform various processing on a digital audio signal received via the ADC 1130 or a digital audio signal received from another component of the electronic device 1001. For example, according to an embodiment, the audio signal processor 1140 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 1140 may be implemented in the form of an equalizer.

The DAC 1150 may convert a digital audio signal into an analog audio signal. For example, according to an embodiment, the DAC 1150 may convert a digital audio signal processed by the audio signal processor 1140 or a digital audio signal obtained from another component (e.g., the processor (1020) or the memory (1030)) of the electronic device 1001 into an analog audio signal.

The audio output mixer 1160 may synthesize a plurality of audio signals, which are to be outputted, into at least one audio signal. For example, according to an embodiment, the audio output mixer 1160 may synthesize an analog audio signal converted by the DAC 1150 and another analog audio signal (e.g., an analog audio signal received via the audio input interface 1110) into at least one analog audio signal.

The audio output interface 1170 may output an analog audio signal converted by the DAC 1150 or, additionally or alternatively, an analog audio signal synthesized by the audio output mixer 1160 to the outside of the electronic device 1001 via the sound output module 1055. The sound output module 1055 may include, for example, a speaker, such as a dynamic driver or a balanced armature driver, or a receiver. According to an embodiment, the sound output module 1055 may include a plurality of speakers. In such a case, the audio output interface 1170 may output audio signals having a plurality of different channels (e.g., stereo channels or 5.1 channels) via at least some of the plurality of speakers. According to an embodiment, the audio output interface 1170 may be connected with the external electronic device 1002 (e.g., an external speaker or a headset) directly via the connecting terminal 1078 or wirelessly via the wireless communication module 1092 to output an audio signal.

According to an embodiment, the audio module 1070 may generate, without separately including the audio input mixer 1120 or the audio output mixer 1160, at least one digital audio signal by synthesizing a plurality of digital audio signals using at least one function of the audio signal processor 1140.

According to an embodiment, the audio module 1070 may include an audio amplifier (not shown) (e.g., a speaker amplifying circuit) that is capable of amplifying an analog audio signal inputted via the audio input interface 1110 or an audio signal that is to be outputted via the audio output interface 1170. According to an embodiment, the audio amplifier may be configured as a module separate from the audio module 1070.

Technical problems to be solved in the disclosure are not limited to those mentioned above, and other technical problems not mentioned herein may be clearly understood by those skilled in the art to which the disclosure pertains from the following descriptions.

According to an embodiment, the electronic device 902 may include the microphone 951, the memory 930 storing instructions, and the one or more processors 920 including a processing circuitry. The instructions, when individually or collectively executed by the one or more processors, may cause the electronic device to perform one or more operations. The one or more operations may include obtaining a volume adjusting model representing a target signal level relative to a noise level. The one or more operations may include obtaining a first audio signal through a microphone of the electronic device. The one or more operations may include obtaining, based on media being played by the electronic device or a paired electronic device at a playback volume, a second audio signal of the media. The one or more operations may include adjusting the playback volume, based on the volume adjusting model, a first intensity of the first audio signal corresponding to the noise level, and a second intensity of the second audio signal corresponding to the target signal level. The one or more operations may include updating the volume adjusting model, based on the playback volume being maintained for a period of time exceeding a first threshold time.

In the electronic device according to an embodiment, the second intensity of the second audio signal may vary while the media is played at the playback volume.

In the electronic device according to an embodiment, the first intensity may be calculated as a weighted average of first intensities per unit time of the first audio signal. The second intensity may be calculated as a weighted average of second intensities per unit time of the second audio signal.

In the electronic device according to an embodiment, the instructions, when individually or collectively executed by the one or more processors, may cause the electronic device to adjust the playback volume, based on the second intensity deviating from a threshold range of the target signal level relative to the noise level corresponding to the first intensity in the volume adjusting model, for a period of time exceeding a second threshold time.

In the electronic device according to an embodiment, the second threshold time may be shorter than the first threshold time.

In the electronic device according to an embodiment, the instructions, when individually or collectively executed by the one or more processors, may cause the electronic device to calculate a cumulative playback time per noise level range, based on the first intensity, and calibrate the volume adjusting model, based on the cumulative playback time.

In the electronic device according to an embodiment, the instructions, when individually or collectively executed by the one or more processors, may cause the electronic device to estimate a sound dose of a user of the electronic device for a defined period, based on the cumulative playback time and the volume adjusting model, and calibrate the volume adjusting model such that the sound dose is below an allowable sound dose.

In the electronic device according to an embodiment, the instructions, when individually or collectively executed by the one or more processors, may cause the electronic device to calibrate, based on a ratio of cumulative playback times corresponding to noise level ranges, portions respectively corresponding to the noise level ranges in the volume adjusting model.

In the electronic device according to an embodiment, the instructions, when individually or collectively executed by the one or more processors, may cause the electronic device to identify a noise control mode set in the electronic device, and obtain, among a plurality of volume adjusting models, the volume adjusting model corresponding to the identified noise control mode.

In the electronic device according to an embodiment, the instructions, when individually or collectively executed by the one or more processors, may cause the electronic device to identify a type of the media, and obtain, among a plurality of volume adjusting models, the volume adjusting model corresponding to the identified type of the media.

Advantages acquired in the disclosure are not limited to the aforementioned advantages, and other advantages not mentioned herein may be clearly understood by those skilled in the art to which the disclosure pertains from the following descriptions.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a microphone;
memory storing instructions; and
one or more processors comprising a processing circuitry,
wherein the instructions, when individually or collectively executed by the one or more processors, cause the electronic device to:
obtaining a volume adjusting model representing a target signal level relative to a noise level;
obtaining a first audio signal through the microphone of the electronic device;
obtaining, based on media being played by the electronic device or a paired electronic device at a playback volume, a second audio signal of the media;
adjusting the playback volume, based on the volume adjusting model, a first intensity of the first audio signal corresponding to the noise level, and a second intensity of the second audio signal corresponding to the target signal level; and
updating the volume adjusting model, based on the playback volume being maintained for a period of time exceeding a first threshold time.

2. The electronic device of claim 1, wherein the second intensity of the second audio signal varies while the media is played at the playback volume.

3. The electronic device of claim 1,
wherein the first intensity is calculated as a weighted average of first intensities per unit time of the first audio signal, and
wherein the second intensity is calculated as a weighted average of second intensities per unit time of the second audio signal.

4. The electronic device of claim 1, wherein the instructions, when individually or collectively executed by the one or more processors, cause the electronic device to adjust the playback volume, based on the second intensity deviating from a threshold range of the target signal level relative to the noise level corresponding to the first intensity in the volume adjusting model, for a period of time exceeding a second threshold time.

5. The electronic device of claim 4, wherein the second threshold time is shorter than the first threshold time.

6. The electronic device of claim 1, wherein the instructions, when individually or collectively executed by the one or more processors, cause the electronic device to:
calculate a cumulative playback time per noise level range, based on the first intensity; and
calibrate the volume adjusting model, based on the cumulative playback time.

7. The electronic device of claim 6, wherein the instructions, when individually or collectively executed by the one or more processors, cause the electronic device to:
estimate a sound dose of a user of the electronic device for a defined period, based on the cumulative playback time and the volume adjusting model; and
calibrate the volume adjusting model such that the sound dose is below an allowable sound dose.

8. The electronic device of claim 7, wherein the instructions, when individually or collectively executed by the one or more processors, cause the electronic device to calibrate, based on a ratio of cumulative playback times corresponding to noise level ranges, portions respectively corresponding to the noise level ranges in the volume adjusting model.

9. The electronic device of claim 1, wherein the instructions, when individually or collectively executed by the one or more processors, cause the electronic device to:
identify a noise control mode set in the electronic device; and
obtain, among a plurality of volume adjusting models, the volume adjusting model corresponding to the identified noise control mode.

10. The electronic device of claim 1, wherein the instructions, when individually or collectively executed by the one or more processors, cause the electronic device to:
identify a type of the media; and
obtain, among a plurality of volume adjusting models, the volume adjusting model corresponding to the identified type of the media.

11. A method comprising:
obtaining a volume adjusting model representing a target signal level relative to a noise level;
obtaining a first audio signal through a microphone of an electronic device;
obtaining, based on media being played by the electronic device or a paired electronic device at a playback volume, a second audio signal of the media;
adjusting the playback volume, based on the volume adjusting model, a first intensity of the first audio signal corresponding to the noise level, and a second intensity of the second audio signal corresponding to the target signal level; and
updating the volume adjusting model, based on the playback volume being maintained for a period of time exceeding a first threshold time.

12. The method of claim 11, wherein the second intensity of the second audio signal varies while the media is played at the playback volume.

13. The method of claim 11,
wherein the first intensity is calculated as a weighted average of first intensities per unit time of the first audio signal, and
wherein the second intensity is calculated as a weighted average of second intensities per unit time of the second audio signal.

14. The method of claim 11, wherein the adjusting of the playback volume comprises adjusting the playback volume, based on the second intensity deviating from a threshold range of the target signal level relative to the noise level corresponding to the first intensity in the volume adjusting model, for a period of time exceeding a second threshold time.

15. The method of claim 14, wherein the second threshold time is shorter than the first threshold time.

16. The method of claim 11, further comprising:
calculating a cumulative playback time per noise level range, based on the first intensity; and
calibrating the volume adjusting model, based on the cumulative playback time.

17. The method of claim 16, wherein the calibrating of the volume adjusting model comprises:
estimating a sound dose of a user of the electronic device for a defined period, based on the cumulative playback time and the volume adjusting model; and
calibrating the volume adjusting model such that the sound dose is below an allowable sound dose.

18. The method of claim 17, wherein the calibrating of the volume adjusting model comprises calibrating, based on a ratio of cumulative playback times corresponding to noise level ranges, portions respectively corresponding to the noise level ranges in the volume adjusting model.

19. The method of claim 11, wherein the obtaining of the volume adjusting model comprises:
identifying a noise control mode set in the electronic device; and
obtaining, among a plurality of volume adjusting models, the volume adjusting model corresponding to the identified noise control mode.

20. The method of claim 11, wherein the obtaining of the volume adjusting model comprises:
identifying a type of the media; and
obtaining, among a plurality of volume adjusting models, the volume adjusting model corresponding to the identified type of the media.
